(19) United States
(12) Patent Application Publication
(10) Pub. No.: US 2021/0034908 A1
(43) Pub. Date: Feb. 4, 2021

(54) INFORMATION PROCESSING DEVICE, INFORMATION PROCESSING SYSTEM, AND CONTROL METHOD

(71) Applicant: NEC Corporation, Tokyo (JP)

(72) Inventors: Yaeko YONEZAWA, Tokyo (JP); Akiko KUBO, Tokyo (JP)

(73) Assignee: NEC Corporation, Tokyo (JP)

(21) Appl. No.: 17/042,557

(22) PCT Filed: Mar. 15, 2019
(86) PCT No.: PCT/JP2019/010933

§ 371 Date: Sep. 28, 2020

(30) Foreign Application Priority Data
Mar. 30, 2018 (JP) 2018-069582

(51) Int. Cl. G06K 9/46; G06K 9/32; G06T 7/80

(52) U.S. Cl. CPC G06K 9/4671; G06K 9/3241; G06K 9/6211; G06T 7/80; G06K 9/3216; G06K 9/4604

(57) ABSTRACT

An information processing system (4000) includes a first information processing apparatus (2000) and a second information processing apparatus (3000). The first information processing apparatus (2000) detects keypoints from a photo image (12), and determines whether the number of the detected keypoints satisfies a predetermined condition. When the number of the keypoints does not satisfy the predetermined condition, the first information processing apparatus (2000) outputs a predetermined notification (40). The second information processing apparatus (3000) recognizes an article by subjecting the photo image (12) to object recognition processing using the keypoints.

### TECHNICAL FIELD

The present invention relates to management of an article.

### BACKGROUND ART

Technologies to evaluate the image quality of photo images have been developed. For example, Patent Document 1 discloses a technology to generate a histogram according to the luminance signal of a photo image and to evaluate a contrast and an exposure on the basis of the histogram. In addition, for example, Patent Document 2 discloses a technology to generate the distribution of the light and shade of an image according to each color component and to determine the level of the poor image quality according to each color component on the basis of such a histogram.

### RELATED DOCUMENTS

### Patent Documents

[Patent Document 1] Japanese Unexamined Patent Publication No. 2003-333381

[Patent Document 2] Japanese Unexamined Patent Publication No. 2007-088552

[Patent Document 3] International Publication No. WO 2016/052383

### SUMMARY OF THE INVENTION

### Technical Problem

One of methods of utilizing image analysis is management an article. Examples of such articles include products displayed on the product shelves of stores and product samples displayed in vending machines. For example, Patent Document 3 discloses a technology to automatically determine whether a relationship between a product put on a display place and a shelf label put on the display place is proper by recognizing the product and a price tag from a photo image obtained by imaging that display place.

In this regard, neither Patent Document 1 nor Patent Document 2 is based on the assumption that image analysis is performed for a photo image after image quality evaluation, and mentions image quality demanded for a photo image subjected to image analysis for management of an article. In addition, Patent Document 3 does not mention the image quality of a photo image to be analyzed.

The present invention was accomplished in view of the problems described above, and one of the objects of the present invention is to provide a technology to evaluate the image quality of a photo image to be analyzed for management of an article.

### Solution to Problem

An information processing apparatus of the present invention includes: 1) a detection unit that detects a keypoint from a photo image generated by imaging a place in which an article is displayed; 2) a determination unit that determines whether a number of the detected keypoints satisfies a predetermined condition; and 3) an output unit that outputs a predetermined notification in a case in which the number of the detected keypoints does not satisfy the predetermined condition.

An information processing system of the present invention includes a first information processing apparatus and a second information processing apparatus.

The first information processing apparatus includes: 1) a detection unit that detects a keypoint from a photo image generated by imaging a place in which an article is displayed; 2) a determination unit that determines whether a number of the detected keypoints satisfies a predetermined condition; and 3) an output unit that outputs a predetermined notification in a case in which the number of the detected keypoints does not satisfy the predetermined condition, and that outputs the photo image in a case in which the detected keypoint does not satisfy the predetermined condition. Using the keypoint detected from the photo image output by the first information processing apparatus, the second information processing apparatus recognizes an article included in the photo image.

A control method of the present invention is a control method executed by a computer. The control method includes: 1) a detection step of detecting a keypoint from a photo image generated by imaging a place in which an article is displayed; 2) a determination step of determining whether a number of the detected keypoints satisfies a predetermined condition; and an output step of outputting a predetermined notification in a case in which the number of the detected keypoints does not satisfy the predetermined condition.

A program of the present invention causes a computer to execute each step included in the control method of the present invention.

### ADVANTAGEOUS EFFECTS OF INVENTION

In accordance with the present invention, there is provided a technology to evaluate the image quality of a photo image to be analyzed for management of an article.

### BRIEF DESCRIPTION OF THE DRAWINGS

The objects described above, other objects, features, and advantages will be further clear from the description of preferred example embodiments described below with reference to the following attached drawings.

FIG. 1 is a diagram conceptually illustrating the operation of an information processing system according to an example embodiment 1.

FIG. 2 is a diagram illustrating the functional configuration of the information processing system.

FIG. 3 is a diagram illustrating the configuration of a computer implementing a first information processing apparatus.

FIG. 4 is a diagram illustrating the configuration of a computer implementing a second information processing apparatus.

FIG. 5 is a flow chart illustrating the flow of processes executed by the information processing system of the example embodiment 1.

FIG. 6 is a diagram illustrating a scene in which an input for specifying a partial region is accepted.

FIG. 7 is a diagram illustrating a case in which a partial region has been set in advance.

FIG. 8 is a diagram conceptually illustrating imaging performed while laterally displacing the position of the imaging.

FIG. 9 is a diagram illustrating a notification of prompting redoing of imaging.

FIG. 10 is a notification of prompting checking of a photo image.

FIG. 11 is a diagram illustrating scenes in which partial regions in which the numbers of keypoints are less than a reference value are highlighted.

### DESCRIPTION OF EXEMPLARY EMBODIMENTS

Example embodiments of the present invention will be described below with reference to the drawings. In all the drawings, the same signs are assigned to the same constituent elements, and a description thereof will not be repeated. Moreover, in each block diagram, each block represents the configuration of a functional unit rather than the configuration of a hardware unit, unless otherwise stated.

In the following discussion, various reference and determined values are prestored in a storage apparatus accessible from a functional configuration unit using the values, unless otherwise stated.

### Example Embodiment 1

### Outline

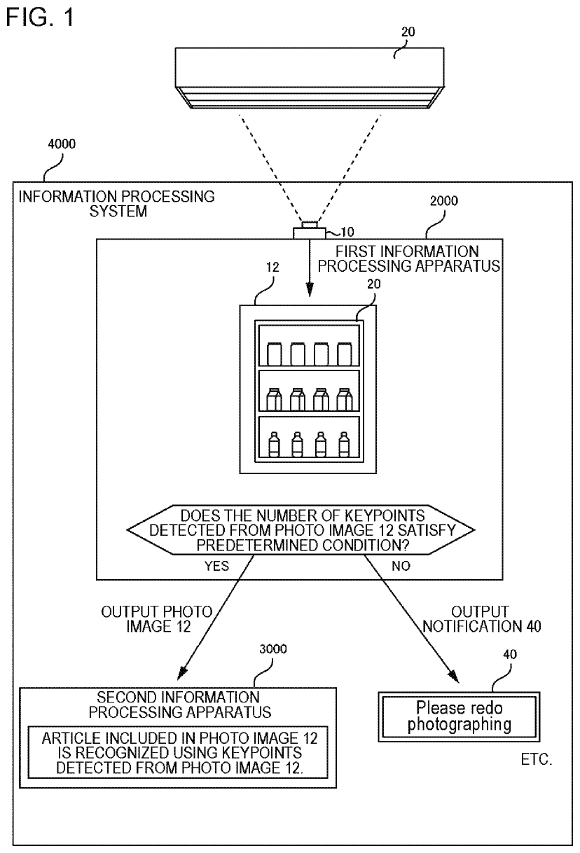

FIG. 1 is a diagram conceptually illustrating the operation of an information processing system 4000 according to an example embodiment 1. Herein, the operation of the information processing system 4000 described with reference to FIG. 1 is illustrative for facilitating understanding of the information processing system 4000, and does not limit the operation of the information processing system 4000. The details and variations of the operation of the information processing system 4000 will be described later.

The information processing system 4000 includes a first information processing apparatus 2000 and a second information processing apparatus 3000. The first information processing apparatus 2000 is utilized for generating a photo image obtained by imaging a display place in which an article is displayed. In FIG. 1, a display place 20 is imaged by a camera 10 disposed in the first information processing apparatus 2000, and consequently, a photo image 12 is generated. The photo image 12 includes the display place 20 and articles displayed in the display place 20. Examples of the articles include a product displayed on a product shelf or a product sample displayed in a vending machine. Note that the product shelf is the display place 20 in the former case while the vending machine is the display place 20 in the latter case.

The display place targeted by the first information processing apparatus 2000 may be a place in which an article is displayed, and is not limited to a place including a plurality of shelves as illustrated in FIG. 1. For example, in a case in which products are laid flat on a desk, the desk is used as the display place.

The first information processing apparatus 2000 outputs the photo image 12. The second information processing apparatus 3000 carries out object recognition processing of the photo image 12 output from the first information processing apparatus 2000. As a result, the second information processing apparatus 3000 recognizes an article displayed in the display place 20. Herein, “recognition of article” means specification of what is the article (for example, an identifier of the article).

One of techniques of object recognition processing is a technique of carrying out object recognition using a keypoint detected from an image. For example, the keypoint is a corner, an edge, a blob, or the like. For example, matching between the group of the keypoints of articles preregistered in a database and the group of keypoints detected from the photo image 12 allows determination whether the group of the keypoints detected from the photo image 12 represents any of the articles. In the case of sufficient matching between the group of the keypoints of any one of the articles registered in the database and the group of the keypoints detected from the photo image 12, the article is recognized from the photo image 12.

Although the article is included in the photo image 12, it may be impossible to recognize the article even when the photo image 12 is subjected to object recognition processing using keypoints. Examples of the causes of such a situation include camera shake, blurring, blown-out highlights, or black crushing in the photo image 12. The number of keypoints that can be detected in an image region in which camera shake or blurring occurs is less than that in an image region in which camera shake, blurring, or the like does not occur. As a result, it is difficult to recognize an article by the matching of the keypoints described above.

The photo image 12 used by the second information processing apparatus 3000 is preferably allowed to be suitable for object recognition processing so that a situation in which it is impossible to recognize an article from the photo image 12 is prevented from occurring. In other words, it is demanded that the first information processing apparatus 2000 outputs the photo image 12 suitable for object recognition processing.

Thus, the first information processing apparatus 2000 has the function of determining whether the photo image 12 is suitable for object recognition processing. Specifically, the first information processing apparatus 2000 detects keypoints from the photo image 12, and determines whether the number of the detected keypoints satisfies a predetermined condition. When the number of the keypoints does not satisfy the predetermined condition, the first information processing apparatus 2000 outputs a predetermined notification 40. The notification 40 is a notification for allowing a user of the first information processing apparatus 2000 to recognize that the photo image 12 is not an image suitable for object recognition processing. For example, the notification 40 is a notification of prompting redoing of photographing. A destination to which the notification 40 is output is, for example, a display apparatus disposed in the information processing apparatus 2000.

On the other hand, when the number of the keypoints satisfies the predetermined condition, the first information processing apparatus 2000 outputs the photo image 12. The second information processing apparatus 3000 recognizes an article by subjecting the photo image 12 to object recognition processing using keypoints. Since the number of the keypoints detected from the photo image 12 satisfies the predetermined condition, a probability that the article can be recognized from the photo image 12 is higher than that in a case in which the number of the keypoints detected from the photo image 12 does not satisfy the predetermined condition.

### Advantageous Effect

The information processing system 4000 of the present example embodiment determines whether the number of the keypoints detected from the photo image 12 satisfies the predetermined condition, and outputs the notification 40 when the predetermined condition is not satisfied. As a result, in a case in which the photo image 12 is not suitable for object recognition processing, a user of the first information processing apparatus 2000 can recognize the case.

A method is also conceivable in which attention is focused on the distribution of the luminance of the photo image 12 or on brightness or contrast derived from the distribution of the luminance, as an index for evaluating the image quality of the photo image 12. In contrast, the information processing system 4000 focuses attention on the number of the keypoints detected from the photo image 12. Evaluation of the photo image 12 with attention on information, i.e., keypoints, directly utilized for recognition of an article as described above enables determination with higher precision whether the photo image 12 is suitable for recognition of an article. In other words, the information processing system 4000 enables the image quality of the photo image 12 utilized for image analysis (recognition of article) to be evaluated with high precision.

The information processing system 4000 also has an advantage that the efficiency of the operation of managing an article is increased. As a method of managing an article using the photo image 12, a method is conceivable in which the second information processing apparatus 3000 is allowed to recognize an article at timing at which the camera 10 generates the display place 20, and next imaging is performed after confirmation that the second information processing apparatus 3000 can recognize the article from the photo image 12. In the method, however, the operation of imaging the display place 20 is delayed until the second information processing apparatus 3000 completes the recognition of the article. Therefore, a time period required for the whole operation becomes longer.

As another method, a method is also conceivable in which the image quality of photo images 12 is not checked in the case of imaging, and article recognition for a batch of the plurality of photo images 12 (e.g., night batch processing) is performed later by the second information processing apparatus 3000. In the method, however, a trouble of redoing imaging of the display place 20 occurs when the second information processing apparatus 3000 fails to recognize an article from the photo images 12. The occurrence of the trouble in the operation causes the deterioration of operation efficiency. Particularly in a case in which an operator such as a rounder goes to a store and performs the operation of imaging the display place 20, a situation in which the rounder must go to the store again later occurs, and operation efficiency is greatly deteriorated.

In contrast, in the information processing system 4000 of the present example embodiment, the first information processing apparatus 2000 checks the image quality of the photo image 12 and outputs the photo image 12, and the second information processing apparatus 3000 uses the checked photo image 12. In such a case, processing performed by the first information processing apparatus 2000 is detection of keypoints and checking of the number of the keypoints, and a time period required for the processing is shorter than that required for processing of recognizing an article. Thus, it may be considered that an influence on the operation of imaging the display place 20 is small even in the case of waiting for the completion of the checking of the photo image 12 by the first information processing apparatus 2000. In a case in which the number of the keypoints of the photo image 12 does not satisfy the predetermined condition, the notification 40 is output, and therefore, a user of the first information processing apparatus 2000 can redo imaging of the display place 20 on the spot. Therefore, the trouble of the operation can be prevented from occurring.

As described above, the information processing system 4000 can prevent the trouble of the operation from occurring while avoiding the delay of the operation of imaging the display place 20 by checking the image quality of the photo image 12 in a process, i.e., checking of the number of keypoints, which is completed for relatively short time. Thus, the efficiency of the overall operation of managing the article is increased.

The information processing system 4000 will be described in more detail below.

### Example of Functional Configuration

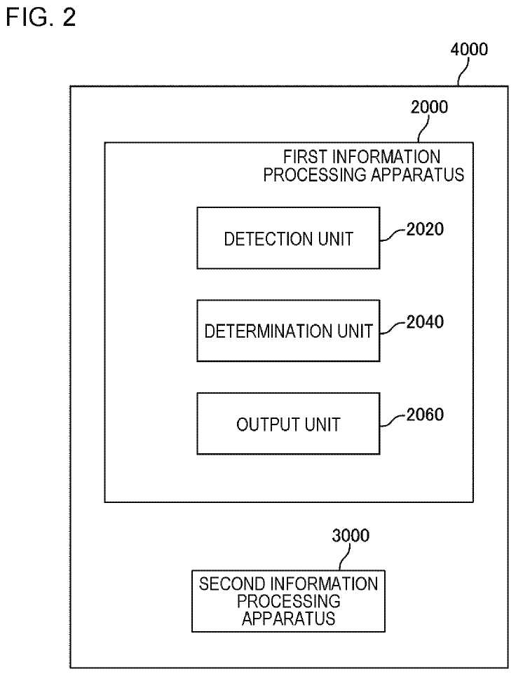

FIG. 2 is a diagram illustrating the functional configuration of the information processing system 4000. The information processing system 4000 includes the first information processing apparatus 2000 and the second information processing apparatus 3000. The first information processing apparatus 2000 includes a detection unit 2020, a determination unit 2040, and an output unit 2060. The detection unit 2020 detects keypoints from the photo image 12. The determination unit 2040 determines whether the detected keypoints satisfy the predetermined condition. The output unit 2060 outputs the notification 40 when the detected keypoints do not satisfy the predetermined condition. On the other hand, the output unit 2060 outputs the photo image 12 when the detected keypoints satisfy the predetermined condition.

The second information processing apparatus 3000 acquires the photo image 12 output by the first information processing apparatus 2000. The second information processing apparatus 3000 recognizes an article included in the photo image 12 by performing object recognition processing using keypoints detected from the photo image 12.

### Example of Hardware Configuration of First Information Processing Apparatus 2000

Each functional configuration unit of the first information processing apparatus 2000 may be implemented by hardware (for example, a hard-wired electronic circuit or the like) implementing each functional configuration unit, or may be implemented by a combination of hardware and software (for example, a combination of an electronic circuit and a program controlling the electronic circuit, or the like). A case in which each functional configuration unit of the first information processing apparatus 2000 is implemented by a combination of hardware and software will be further described below.

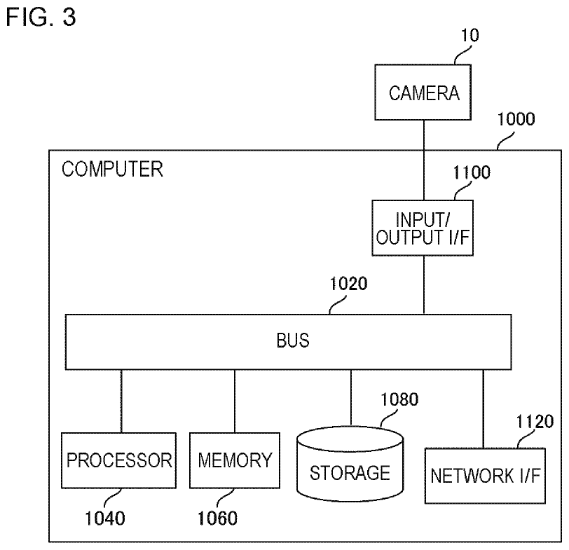

FIG. 3 is a diagram illustrating the configuration of a computer 1000 implementing the first information processing apparatus 2000. The computer 1000 is one of various computers. For example, the computer 1000 is a mobile computer such as a tablet terminal, a smartphone, or a head mount display. The computer 1000 may be a dedicated computer designed to implement the first information processing apparatus 2000, or may be a general-purpose computer.

The computer 1000 includes a bus 1020, a processor 1040, a memory 1060, a storage device 1080, an input/output interface 1100, and a network interface 1120. The bus 1020 is a data transmission line configured so that the processor 1040, the memory 1060, the storage device 1080, the input/output interface 1100, and the network interface 1120 send and receive data to and from each other. However, a method of connecting the processor 1040 and the like to each other is not limited to bus connection. The processor 1040 is a processor implemented by a central processing unit (CPU), a graphics processing unit (GPU), or the like. The memory 1060 is a main storage apparatus implemented by a random access memory (RAM) or the like. The storage device 1080 is an auxiliary storage apparatus implemented by a hard disk, a solid state drive (SSD), a memory card, a read only memory (ROM), or the like.

The input/output interface 1100 is an interface for connecting the computer 1000 and an input/output device to each other. For example, an input apparatus such as a keyboard, or an output apparatus such as a display apparatus is connected to the input/output interface 1100. In addition, for example, the camera 10 is connected to the input/output interface 1100.

The network interface 1120 is an interface for connecting the computer 1000 to a network. The communication network is, for example, a local area network (LAN) or a wide area network (WAN). A method in which the network interface 1120 allows connection to the network may be wireless connection, or may be wireline connection.

The storage device 1080 stores program modules implementing each function of the first information processing apparatus 2000. The processor 1040 executes each of the program modules, whereby each function corresponding to the program module is implemented.

### With Regard to Camera 10

The camera 10 is any imaging apparatus that can perform imaging and generate an image representing an imaging result. For example, when the first information processing apparatus 2000 is implemented by a mobile terminal such as a smartphone, a camera disposed integrally in the first information processing apparatus 2000 can be used as the camera 10. However, the camera 10 may be disposed separately from the first information processing apparatus 2000.

### Example of Hardware Configuration of Second Information Processing Apparatus 3000

Each functional configuration unit of the second information processing apparatus 3000 may be implemented by hardware (for example, a hard-wired electronic circuit or the like) implementing each functional configuration unit, or may be implemented by a combination of hardware and software (for example, a combination of an electronic circuit and a program controlling the electronic circuit, or the like). A case in which each functional configuration unit of the second information processing apparatus 3000 is implemented by a combination of hardware and software will be further described below.

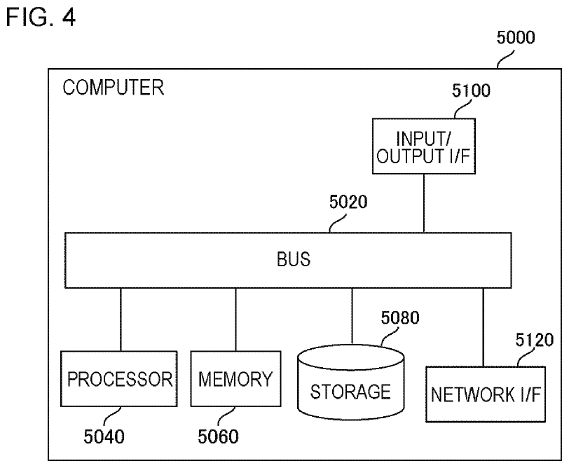

FIG. 4 is a diagram illustrating the configuration of a computer 5000 implementing the second information processing apparatus 3000. The computer 5000 is one of various computers. For example, the computer 5000 is a personal computer (PC), a server machine, or the like. The computer 5000 may be a dedicated computer designed to implement the second information processing apparatus 3000, or may be a general-purpose computer.

The computer 5000 includes a bus 5020, a processor 5040, a memory 5060, a storage device 5080, an input/output interface 5100, and a network interface 5120. Respective functions possessed by the bus 5020, the processor 5040, the memory 5060, the storage device 5080, the input/output interface 5100, and the network interface 5120 are similar to the functions possessed by the bus 1020, the processor 1040, the memory 1060, the storage device 1080, the input/output interface 1100, and the network interface 1120.

However, the storage device 5080 stores program modules for implementing each function of the second information processing apparatus 3000. The processor 5040 executes each of the program modules, whereby each function corresponding to the program module is implemented.

### Flow of Processes

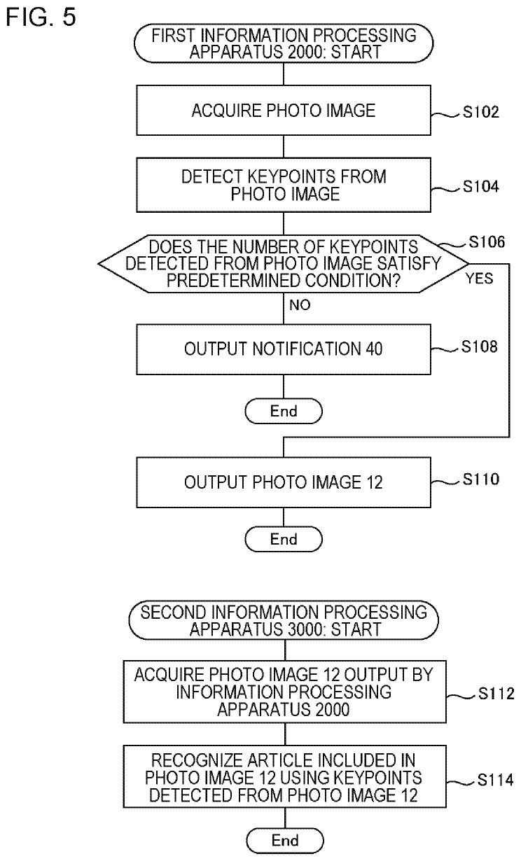

FIG. 5 is a flow chart illustrating the flow of processes executed by the information processing system 4000 of the example embodiment 1. The detection unit 2020 acquires the photo image 12 (S102). The detection unit 2020 detects keypoints from the photo image 12 (S104). The output unit 2060 determines whether the number of the keypoints detected from the photo image 12 satisfies a predetermined condition (S106). When the predetermined condition is not satisfied (S106: NO), the output unit 2060 outputs the notification 40 (S108). On the other hand, when the predetermined condition is satisfied (S106: YES), the output unit 2060 outputs the photo image 12 (S110).

The second information processing apparatus 3000 acquires the photo image 12 output by the output unit 2060 (S112). The second information processing apparatus 3000 recognizes an article included in the photo image 12 using keypoints detected from the photo image 12 (S114).

The first information processing apparatus 2000 has various opportunities to execute a series of processes illustrated in FIG. 5. For example, in response to generation of the photo image 12 by the camera 10, the detection unit 2020 acquires the photo image 12, whereby the above-described series of processes is executed. In addition, for example, it is also acceptable to accept an input operation which specifies the photo image 12 and to execute the series of processes, illustrated in FIG. 5, for the specified photo image 12. In such a case, the first information processing apparatus 2000 executes the series of processes illustrated in FIG. 5 with an opportunity at which an input operation is accepted from a user.

The second information processing apparatus 3000 has various opportunities to execute the series of processes illustrated in FIG. 5. For example, in response to output of the photo image 12 by the first information processing apparatus 2000, the second information processing apparatus 3000 executes the above-described processes, illustrated in FIG. 5, for the photo image 12. In addition, for example, the second information processing apparatus 3000 may execute the above-described series of processes for one or more photo images 12 at predetermined timing. In such a case, for example, the one or more photo images 12 output from the first information processing apparatus 2000 are stored in a storage apparatus, and the second information processing apparatus 3000 reads out the photo images 12 from the storage apparatus. In other words, the one or more photo images 12 stored in the storage apparatus are batch-processed at the predetermined timing.

### Acquisition of Photo Image 12: S102

The detection unit 2020 acquires the photo image 12 (S102). For example, the detection unit 2020 acquires the photo image 12 from the storage apparatus in which the photo image 12 is stored. The storage apparatus in which the photo image 12 is stored may be disposed in or outside the detection unit 2020. In addition, for example, the detection unit 2020 acquires the photo image 12 input by an input operation by a user. In addition, for example, the detection unit 2020 acquires the photo image 12 by receiving the photo image 12 sent by another apparatus.

In such a case, the photo image 12 acquired by the detection unit 2020 may be a photo image itself generated by the camera 10, or may be a photo image obtained by subjecting a photo image, generated by the camera 10, to some kind of processing. In the latter case, for example, the photo image 12 is generated by removing an unnecessary image region by trimming a photo image generated by the camera 10, or by performing camera-shake compensation or color correction of a photo image generated by the camera 10.

### Detection of Keypoints: S104

The detection unit 2020 detects keypoints from the photo image 12 (S104). In such a case, an existing technology can be used as a technology to detect a keypoint such as an edge, a corner, or a blob from the image.

### Determination by Determination Unit 2040: S106

The determination unit 2040 determines whether the number of the keypoints detected from the photo image 12 satisfies the predetermined condition (S106). In such a case, the predetermined condition is conceptually a condition satisfied when the photo image 12 is suitable for use in recognition of an article. Examples of variations of such a condition will be described below.

### <<The Number of Keypoints in Whole Photo Image 12>>

For example, the predetermined condition is a condition that “the number of keypoints detected from the whole photo image 12 is equal to or greater than a reference value”. In such a case, the detection unit 2020 carries out a process of detecting keypoints over the whole photo image 12. The determination unit 2040 determines whether the number of the keypoints detected from the whole photo image 12 is equal to or greater than the reference value. A case in which the number of the detected keypoints is equal to or greater than the reference value means that the predetermined condition is satisfied, whereas a case in which the number of the detected keypoints is less than the reference value means that the predetermined condition is not satisfied.

<<The Number of Keypoints Detected from Specific Region of Photo Image 12>>

For example, the predetermined condition is a condition that “the number of keypoints detected from a partial region included in the photo image 12 is equal to or greater than a reference value”. The detection unit 2020 carries out a process of detecting the keypoints in the partial region in the photo image 12. The determination unit 2040 determines whether the number of the keypoints detected from the partial region is equal to or greater than the reference value.

The partial region targeted for detecting the keypoints may be specified by a user, or may be determined in advance. Each case will be described below.

<<<Case in which User Specifies Partial Region>>>

For example, the first information processing apparatus 2000 displays the photo image 12 on a display apparatus disposed in the first information processing apparatus 2000, and accepts an input for specifying a partial region in the photo image 12 displayed on the display apparatus. The number of partial regions which can be specified may be one or plural.

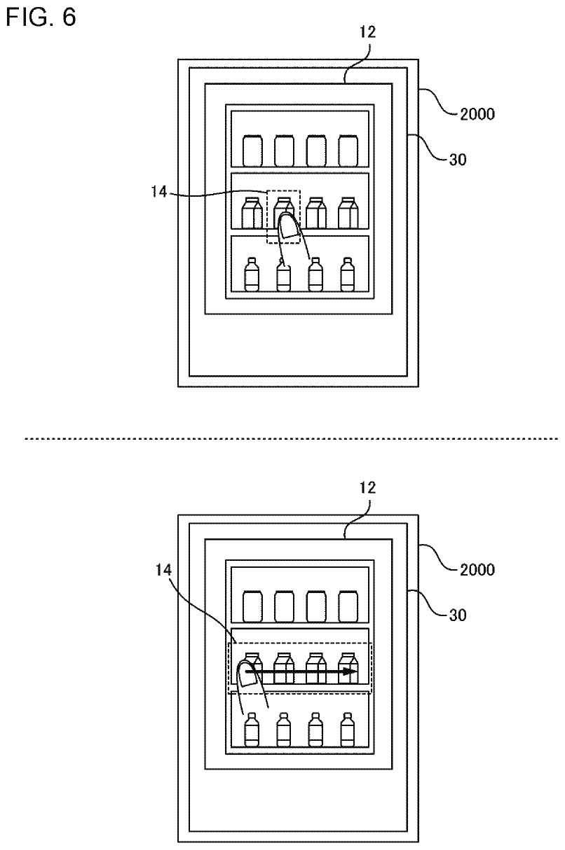

FIG. 6 is a diagram illustrating a scene in which an input for specifying a partial region is accepted. In FIG. 6, a display apparatus 30 disposed in the first information processing apparatus 2000 includes a touch panel.

In the example of the upper section of FIG. 6, a user taps the display apparatus 30. The first information processing apparatus 2000 defines, as a partial region 14, a region of which the center is a tapped position and which has a predetermined size. On the other hand, in the example of the lower section of FIG. 6, the user drags the display apparatus 30. For example, in the case of moving a region having a predetermined size from the start point to end point of a drag position, the first information processing apparatus 2000 defines, as the partial region 14, the whole area through which the region passes.

In such a case, the partial region 14 is preferably a region including an article. In order to enable the article to be recognized from the photo image 12, it is necessary to detect a sufficient number of keypoints in a region including the article, and therefore, it is preferable to validate the number of keypoints for a region including the article.

Thus, a user preferably specifies a region including an article in an input operation. For example, in the example of the upper section of FIG. 6, the user specifies the region including an article by tapping the position of the article. In the example of the lower section of FIG. 6, the user specifies the region including articles by dragging the region in which the articles are displayed in product shelves.

<<<Case in which Partial Region has Been Set in Advance>>>

The detection unit 2020 detects keypoints from the partial region 14 which has been set in advance. Information defining the partial region 14 has been stored in advance in a storage apparatus accessible from the detection unit 2020.

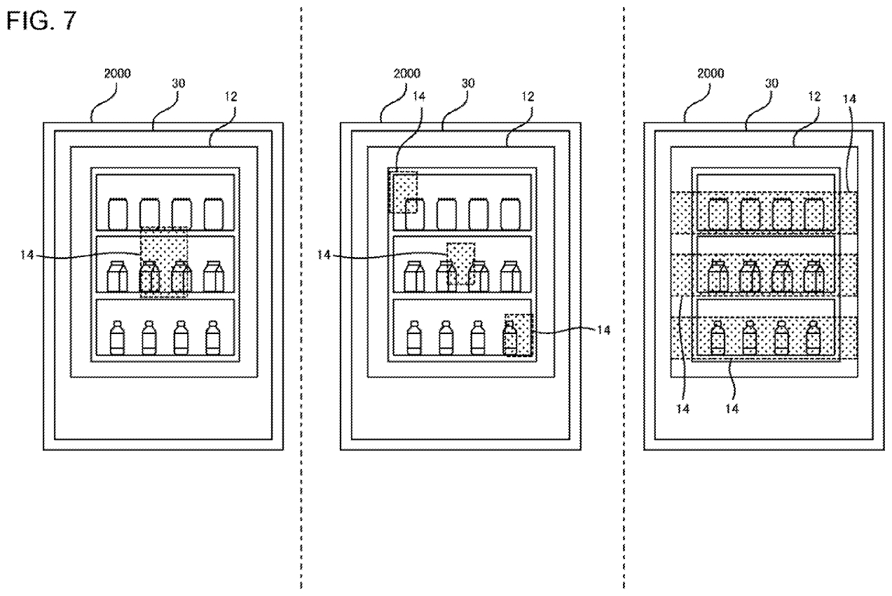

The partial region 14 may be any region. FIG. 7 is a diagram illustrating a case in which a partial region has been set in advance. The left example includes one partial region 14, which is located in the center of the photo image 12. The central example includes three partial regions 14, which are located in the upper left, center, and lower right of the photo image 12, respectively. The right example includes three partial regions 14, each of which is a region where articles are presumed to be displayed in the photo image 12.

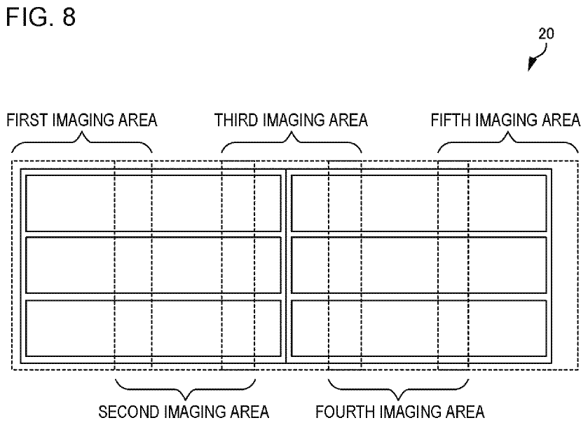

A method of presuming a region where articles are displayed in the photo image 12 will now be described. It is assumed that a user of the first information processing apparatus 2000 images articles displayed in the display place 20 by repeating imaging of the display place 20 while laterally displacing the position of the imaging. FIG. 8 is a diagram conceptually illustrating imaging performed while laterally displacing the position of the imaging. In FIG. 8, the horizontally long display place 20 is imaged while laterally displacing the position of the display place 20 five times. Note that imaging areas are partly overlapped so that the articles are prevented from failing to be imaged.

In the case of performing imaging while laterally displacing the position in such a manner, the height-direction positions of displayed articles in the photo images 12 generated after the second imaging can be presumed to be the same as that in the first photo image 12. Thus, the first information processing apparatus 2000 accepts, from a user, an input for specifying a region where an article is displayed in the first photo image 12. For example, the input is similar to the input illustrated in in lower section of FIG. 6. The first information processing apparatus 2000 automatically sets, as the partial region 14, each of the same regions as the region specified as described above, in the thereafter generated photo images 12.

### <<Reference Value According to Each Kind of Article>>

A reference value set in the whole photo image 12 or the partial region 14 may vary according to the kind of a displayed article. This is because an article having a more complicated shape or pattern tends to result in an increase in the number of reference values necessary for recognition of the article. For example, information in which the kinds of articles and reference values are associated with each other is stored in a storage apparatus in advance. The information processing apparatus 2000 accepts an input for specifying the kind of an article displayed in the display place 20, acquires a reference value corresponding to the specified kind from the storage apparatus, and uses the reference value.

### <<With Regard to Reference Value of Plurality of Existing Partial Region 14>>

When there are a plurality of partial regions 14, a reference value may be set for the total number of keypoints detected from the partial regions 14, or may be set for the number of keypoints detected from each partial region 14. In the former case, the predetermined condition is a condition that “the total number of the keypoints detected from the partial regions 14 are equal to or greater than the reference value”. For example, the determination unit 2040 regards, as the reference value, a value obtained by multiplying a value, obtained by totalizing pixels included in the partial regions 14, by a unit reference value.

The setting of the reference value for the total number of the keypoints detected from the partial regions 14 has an advantage that even when there is a partial region 14 including a small number of detected keypoints, the predetermined condition is satisfied by detection of a sufficient number of keypoints from the other partial regions 14. For example, when keypoints are detected from the partial region 14 set in advance as in the example of the middle of FIG. 7, a region including no article (for example, the frame of a product shelf) may exist in the plurality of partial regions 14. The number of detected keypoints in such a region including no article is more likely to be smaller than that in a region including an article. However, there is no harm in recognition of an article when a sufficient number of keypoints are obtained from a region including the article, and therefore, the number of keypoints detected from such a region including no article may be small. Thus, even when there is a partial region 14 including no article, detection of a sufficient number of keypoints from the other partial regions 14 is allowed to satisfy the predetermined condition by setting the reference value for the total number of the keypoints detected from the partial regions 14.

In a case in which the reference value is set for the number of the keypoints detected from each partial region 14, for example, the determination unit 2040 outputs the notification 40 when there is at least one partial region 14 in which the number of keypoints is less than the reference value. In other words, “the number of keypoints is equal to or greater than a reference value in all the partial regions 14” is set at the predetermined condition. For example, when a user sets a plurality of partial regions 14 by specifying a plurality of article positions, it is necessary that all the partial regions 14 can be used for recognizing the articles. Thus, a sufficient number of keypoints are allowed to be detected for all the partial regions 14.

However, the number of partial regions 14 in which the number of keypoints is equal to or greater than a reference value may also be set at a reference value. Specifically, the determination unit 2040 outputs the notification 40 when the number of partial regions 14 in which the number of keypoints is equal to or greater than a reference value is less than a predetermined number. In other words, “the number of keypoints in partial regions 14 of which the number is equal to or greater than a predetermined number is equal to or greater than a reference value” is set at the predetermined condition.

Note that when a reference value is set with respect to the number of the keypoints detected from each partial region 14, for example, the determination unit 2040 regards, as the reference value of each partial region 14, a value obtained by multiplying the number of pixels included in the partial region 14 by a unit reference value.

<<With Regard to Case in which Plurality of Photo Images 12 are Partially Overlapped>>

As illustrated in FIG. 8, there is a case in which a user of the first information processing apparatus 2000 images articles displayed in the display place 20 by repeating imaging of the display place 20 while laterally displacing the position of the imaging. In such a case, it is preferable that imaging areas adjacent to each other are partly overlapped as illustrated in FIG. 8.

In such a case, when the imaging areas adjacent to each other are partly overlapped, a partial region in a certain photo image 12 and a partial region in a subsequently generated photo image 12 become regions in which a generally identical place is imaged. Hereinafter, the region is referred to as a common region. When the two photo images 12 are appropriate images without blurring or the like, the difference between the numbers of keypoints detected from the common region is considered to be small.

Thus, when the first information processing apparatus 2000 is managed in a method in which imaging is performed while laterally displacing the position of the imaging in such a manner, the first information processing apparatus 2000 may set the previously-described common region as one of partial regions 14. However, the common region can be set as the partial region 14 in the photo images 12 generated by the second or later imaging.

In such a case, a reference value for the number of keypoints detected from the partial region 14 corresponding to the common region may also be set based on the number of keypoints detected from the common region of the previous photo image 12. For example, αN obtained by multiplying the number N of the keypoints detected from the common region of the previous photo image 12 by a predetermined coefficient α is regarded as the reference value. In the case of α=1, the number of the keypoints detected from the common region of the previous photo image 12 is regarded as the reference value. On the other hand, in the case of α<1, a value that is less than the number of the keypoints detected from the common region of the previous photo image 12 is regarded as the reference value. A decrease in the number of the keypoints to a degree can be permitted by setting α at a value that is close to 1 and less than 1 (for example, 0.9 or the like).

### Output of Notification 40: S108

The output unit 2060 outputs the notification 40 (S108) when the number of the keypoints detected from the photo image 12 does not satisfy the predetermined condition (S106: NO). The notification 40 is a notification for allowing a user of the first information processing apparatus 2000 to recognize that the photo image 12 is not suitable for recognizing an article.

For example, the notification 40 is a notification of prompting a user to redo imaging, as described above. The notification enables the user to recognize that the redoing of the imaging (i.e., the redoing of the generation of the photo image 12) should be performed. The user performs imaging by the camera 10 again by operating the first information processing apparatus 2000. The first information processing apparatus 2000 executes a series of processes by handling a consequently generated photo image as a new photo image 12.

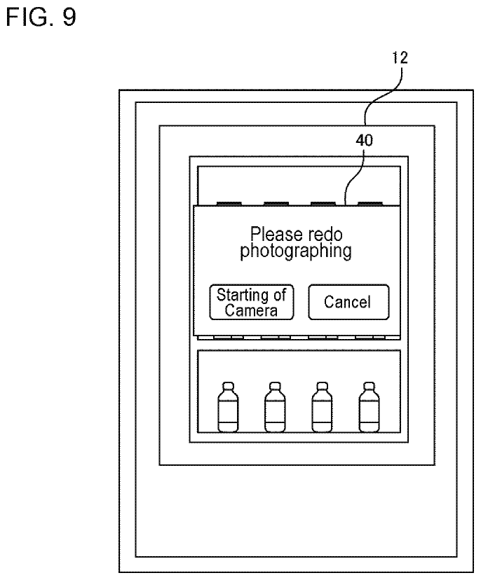

FIG. 9 is a diagram illustrating a notification of prompting redoing of imaging. In FIG. 9, the notification 40 of prompting redoing of imaging is displayed on the display apparatus 30 disposed in the first information processing apparatus 2000. When a user pushes a button “Starting of Camera” included in the notification 40, the first information processing apparatus 2000 is switched to a state in which imaging can be performed by the camera 10.

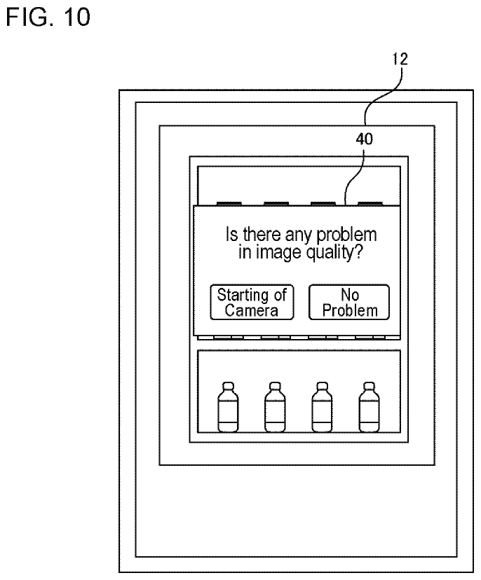

In addition, for example, the predetermined notification is a notification of prompting checking of whether the photo image 12 is appropriate. FIG. 10 is a notification of prompting checking of the photo image 12. When it is determined that there is a problem, a user redoes imaging by pushing a button “Starting of Camera”. On the other hand, the user of the first information processing apparatus 2000 pushes a button “No Problem” when visually confirming the photo image 12 and determining that there is no problem. In such a case, the output unit 2060 outputs the photo image 12.

A configuration using a notification of prompting checking of whether the photo image 12 is appropriate has, for example, the following advantage. First, it is assumed that a plurality of set partial regions 14 include a partial region 14 including no article. In such a case, the number of keypoints detected from the partial region 14 is small, and therefore, the number of the keypoints may satisfy no predetermined condition. In such a case, however, the photo image 12 is considered to be more likely to be used for recognizing an article without any problem when the number of keypoints detected from the other partial regions 14 including articles is sufficiently large.

Thus, by outputting a notification of prompting checking of whether the photo image 12 is appropriate, a user can confirm each partial region 14 and can confirm whether the photo image 12 can be used for recognizing an article without any problem as described above. When the photo image 12 can be used for recognizing an article without any problem, redoing of imaging can be avoided by pushing the button “No Problem”.

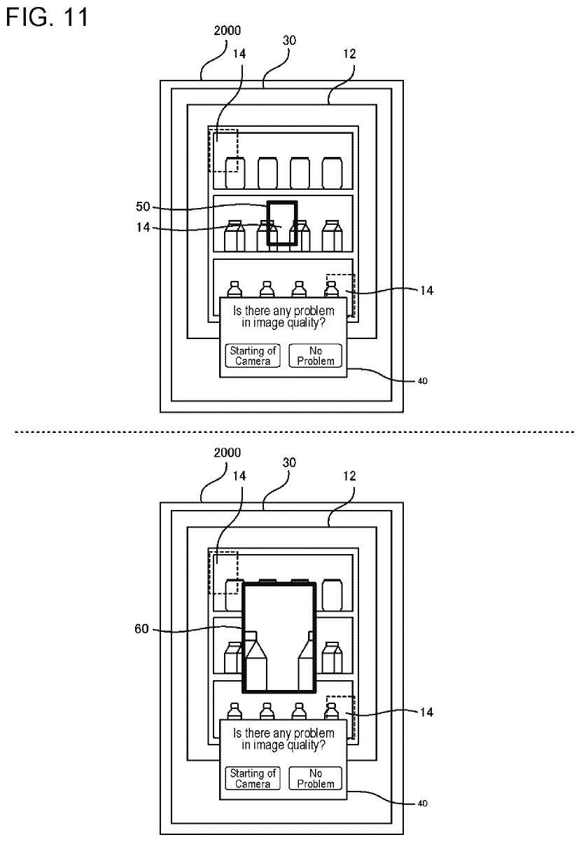

When the determination unit 2040 determines with respect to the partial regions 14, it is preferable that the output unit 2060 highlights a partial region 14 in which the number of keypoints is less than the reference value. FIG. 11 is a diagram illustrating a scene in which partial regions 14 in which the numbers of keypoints are less than a reference value are highlighted.

In the upper section of FIG. 11, a frame 50 highlights the partial region 14 in which the number of keypoints is less than a reference value. In the lower section of FIG. 11, a magnified view (reference numeral 60) of the partial region 14 in which the number of keypoints is less than a reference value allows the partial region 14 to be highlighted. Note that in actuality, dotted lines representing the partial regions 14 need not be displayed.

A highlighting method is not limited to the method described above. For example, various methods can be adopted in which a mark is placed, and in which a color is changed.

### Output of Photo Image 12: S110

The output unit 2060 outputs the photo image 12 (S110) when the number of the keypoints detected from the photo image 12 satisfies the predetermined condition (S106: YES). The photo image 12 output in such a case is used by the second information processing apparatus 3000, and therefore, it is necessary to output the photo image 12 in an aspect in which the photo image 12 can be used by the second information processing apparatus 3000.

For example, the output unit 2060 allows a predetermined storage apparatus (for example, a network attached storage (NAS) connected communicatably to both the first information processing apparatus 2000 and the second information processing apparatus 3000) accessible from the second information processing apparatus 3000 to store the photo image 12. In addition, for example, the output unit 2060 may send the photo image 12 to the second information processing apparatus 3000.

### Acquisition of Photo Image 12 by Second Information Processing Apparatus 3000: S108

The second information processing apparatus 3000 acquires the photo image 12 output by the output unit 2060 (S108). For example, when the output unit 2060 allows the photo image 12 to be stored in a storage apparatus, the second information processing apparatus 3000 acquires the photo image 12 by reading out the photo image 12 from the storage apparatus. In addition, for example, when the first information processing apparatus 2000 sends the photo image 12 to the second information processing apparatus 3000, the second information processing apparatus 3000 acquires the photo image 12 by receiving the photo image 12.

### Recognition of Article: S110

The second information processing apparatus 3000 recognizes an article using the keypoints detected from the photo image 12 (S110). An existing technology can be used for object recognition using keypoints.

The second information processing apparatus 3000 may use the keypoints, detected from the photo image 12 by the detection unit 2020, for recognizing the article. In such a case, the output unit 2060 outputs information representing the keypoints detected from the photo image 12 in association with the photo image 12. Such a manner eliminates redundant execution of a process of detecting keypoints from the photo image 12, and therefore enables promotion of the efficiency of the overall processes of the information processing system 4000. However, when a region in which the keypoints are detected by the detection unit 2020 is a part of the photo image 12, the second information processing apparatus 3000 detects keypoints in at least the remaining region.

The second information processing apparatus 3000 need not use the keypoints detected from the photo image 12 by the detection unit 2020. In such a case, the second information processing apparatus 3000 carries out a process of detecting keypoints from the photo image 12. When the second information processing apparatus 3000 also detects the keypoints, an algorithm used for detecting keypoints by the first information processing apparatus 2000 and an algorithm used for detecting keypoints by the second information processing apparatus 3000 are preferably identical to each other. This is because when the algorithms are different from each other, it is possible that the keypoints detected by the first information processing apparatus 2000 are not detected by the second information processing apparatus 3000, and the number of keypoints is insufficient in the second information processing apparatus 3000.

However, it is enough if the number of keypoints detected by the second information processing apparatus 3000 is more than the number of keypoints detected by the first information processing apparatus 2000, and therefore, it is also acceptable to determine respective algorithms for detecting keypoints, used in the first information processing apparatus 2000 and the second information processing apparatus 3000 in such a manner.

The example embodiments of the present invention have been described above with reference to the drawings. However, the example embodiments are illustrative of the present invention, and various configurations other than the above can also be adopted.

For example, the information processing system 4000 described above includes the first information processing apparatus 2000 and the second information processing apparatus 3000. However, the first information processing apparatus 2000 may also play the role of the second information processing apparatus 3000. In other words, the first information processing apparatus 2000 may carry out a process of recognizing an article from a photo image 12. In such a case, the information processing system 4000 may include only the first information processing apparatus 2000, and need not include the second information processing apparatus 3000.

Some or all of the example embodiments described above can also be described as in the following supplementary notes, but are not limited to the following.

1. An information processing apparatus including:

a detection unit that detects a keypoint from a photo image generated by imaging a place in which an article is displayed;

a determination unit that determines whether a number of the detected keypoints satisfies a predetermined condition; and

an output unit that outputs a predetermined notification in a case in which the number of the detected keypoints does not satisfy the predetermined condition.

2. The information processing apparatus according to item 1, wherein the predetermined condition is in that a number of the keypoints detected from the whole photo image is equal to or greater than a reference value.

3. The information processing apparatus according to item 1, wherein

the detection unit detects a keypoint from each of one or more partial regions included in the photo image, and

the predetermined condition is in that
a total of numbers of keypoints detected from the plurality of partial regions is equal to or greater than a reference value,
all of the numbers of keypoints detected from the plurality of partial regions are equal to or greater than a reference value, or
all of the numbers of keypoints detected in equal to or greater than a predetermined number of partial regions among the plurality of partial regions are equal to or greater than a reference value.
   4. The information processing apparatus according to item 2 or 3, wherein

the information processing apparatus accepts an input of a kind of an article included in the photo image, and

the determination unit acquires a reference value of the number of the keypoints corresponding to the input kind of the article from a storage apparatus in which a reference value of the number of the keypoints is stored in association with the kind of an article, and determines whether the number of the detected keypoints satisfies the predetermined condition using the acquired reference value.

5. The information processing apparatus according to any one of items 1 to 4, wherein the predetermined notification includes a notification of prompting reimaging of the display place.
6. The information processing apparatus according to any one of items 1 to 5, wherein the predetermined notification includes a view representing a partial region in which the number of detected keypoints is less than a reference value.
7. The information processing apparatus according to item 6, wherein the predetermined notification includes a magnified view of a partial region in which the number of detected keypoints is less than a reference value.
8. The information processing apparatus according to any one of items 1 to 7, wherein
the output unit outputs the photo image when the number of the detected keypoints satisfies a predetermined condition, and
recognition of an article included in the photo image is performed by using a keypoint detected from the output photo image.
9. An information processing system including a first information processing apparatus and a second information processing apparatus, wherein

the first information processing apparatus includes
a detection unit that detects a keypoint from a photo image generated by imaging a place in which an article is displayed,
a determination unit that determines whether a number of the detected keypoints satisfies a predetermined condition, and
an output unit that outputs a predetermined notification in a case in which the number of the detected keypoints does not satisfy the predetermined condition, and that outputs the photo image in a case in which the detected keypoint does not satisfy the predetermined condition, and

the second information processing apparatus recognizes an article included in the photo image, using a keypoint detected from the photo image output by the first information processing apparatus.

10. The information processing system according to item 9, wherein the predetermined condition is in that a number of keypoints detected from the whole photo image is equal to or greater than a reference value.
11. The information processing system according to item 9, wherein

the detection unit detects a keypoint from each of one or more partial regions included in the photo image, and

the predetermined condition is in that
a total of numbers of keypoints detected from the plurality of partial regions is equal to or greater than a reference value,
all of the numbers of keypoints detected from the plurality of partial regions are equal to or greater than a reference value, or
all of the numbers of keypoints detected in equal to or greater than a predetermined number of partial regions among the plurality of partial regions are equal to or greater than a reference value.
   12. The information processing system according to item 10 or 11, wherein

the information processing apparatus accepts an input of a kind of an article included in the photo image, and

the determination unit acquires a reference value of the number of the keypoints corresponding to the input kind of the article from a storage apparatus in which a reference value of the number of the keypoints is stored in association with the kind of an article, and determines whether the number of the detected keypoints satisfies the predetermined condition using the acquired reference value.

13. The information processing system according to any one of items 9 to 12, wherein the predetermined notification includes a notification of prompting reimaging of the display place.
14. The information processing system according to any one of items 9 to 13, wherein the predetermined notification includes a view representing a partial region in which the number of detected keypoints is less than a reference value.
15. The information processing system according to item 14, wherein the predetermined notification includes a magnified view of the partial region in which the number of detected keypoints is less than the reference value.
16. A control method executed by a computer, the control method including:

a detection step of detecting a keypoint from a photo image generated by imaging a place in which an article is displayed;

a determination step of determining whether a number of the detected keypoints satisfies a predetermined condition; and

an output step of outputting a predetermined notification in a case in which a number of the detected keypoints does not satisfy a predetermined condition.

17. The control method according to item 16, wherein the predetermined condition is in that a number of the keypoints detected from the whole photo image is equal to or greater than a reference value.
18. The control method according to item 16, wherein

detecting a keypoint from each of one or more partial regions included in the photo image in the detection step, and

the predetermined condition is in that
a total of numbers of keypoints detected from the plurality of partial regions is equal to or greater than a reference value,
all of the numbers of keypoints detected from the plurality of partial regions are equal to or greater than a reference value, or
all of the numbers of keypoints detected in equal to or greater than a predetermined number of partial regions among the plurality of partial regions are equal to or greater than a reference value.
   19. The control method according to item 17 or 18, further including

accepting an input of a kind of an article included in the photo image,

wherein, in the determination step, acquiring a reference value of the number of the keypoints corresponding to the input kind of the article from a storage apparatus in which a reference value of the number of the keypoints is stored in association with the kind of an article, and determining whether the number of the detected keypoints satisfies the predetermined condition, using the acquired reference value.

20. The control method according to any one of items 16 to 19, wherein the predetermined notification includes a notification of prompting reimaging of the display place.
21. The control method according to any one of items 16 to 20, wherein the predetermined notification includes a view representing a partial region in which the number of detected keypoints is less than a reference value.
22. The control method according to item 21, wherein the predetermined notification includes a magnified view of the partial region in which the number of detected keypoints is less than the reference value.
23. The control method according to any one of items 16 to 22, wherein

in the output step, outputting the photo image when the number of the detected keypoints satisfies the predetermined condition, and

recognition of an article included in the photo image is performed by using a keypoint detected from the output photo image.

24. A program causing a computer to execute each step in the control method according to any one of items 16 to 23.

This application claims priority based on Japanese Patent Application No. 2018-069582, which was filed on Mar. 30, 2018, and of which the entire disclosure is incorporated herein.

1. An information processing apparatus comprising:
a detection unit that detects a keypoint from a photo image generated by imaging a place in which an article is displayed;
a determination unit that determines whether a number of the detected keypoints satisfies a predetermined condition; and
an output unit that outputs a predetermined notification in a case in which the number of the detected keypoints does not satisfy the predetermined condition.

2. The information processing apparatus according to claim 1, wherein the predetermined condition is in that a number of the keypoints detected from the whole photo image is equal to or greater than a reference value.

3. The information processing apparatus according to claim 1, wherein
the detection unit detects a keypoint from each of one or more partial regions included in the photo image, and
the predetermined condition is in that
a total of numbers of keypoints detected from the plurality of partial regions is equal to or greater than a reference value,
all of the numbers of keypoints detected from the plurality of partial regions are equal to or greater than a reference value, or
all of the numbers of keypoints detected in equal to or greater than a predetermined number of partial regions among the plurality of partial regions are equal to or greater than a reference value.

4. The information processing apparatus according to claim 2, wherein
the information processing apparatus accepts an input of a kind of an article included in the photo image, and
the determination unit acquires a reference value of the number of the keypoints corresponding to the input kind of the article from a storage apparatus in which a reference value of the number of the keypoints is stored in association with the kind of an article, and determines whether the number of the detected keypoints satisfies the predetermined condition using the acquired reference value.

5. The information processing apparatus according to claim 1, wherein the predetermined notification includes a notification of prompting reimaging of the display place.

6. The information processing apparatus according to claim 1, wherein the predetermined notification includes a view representing a partial region in which the number of detected keypoints is less than a reference value.

7. The information processing apparatus according to claim 6, wherein the predetermined notification includes a magnified view of a partial region in which the number of detected keypoints is less than a reference value.

8. The information processing apparatus according to claim 1, wherein
the output unit outputs the photo image when the number of the detected keypoints satisfies a predetermined condition, and
recognition of an article included in the photo image is performed by using a keypoint detected from the output photo image.

9. An information processing system comprising a first information processing apparatus and a second information processing apparatus, wherein
the first information processing apparatus comprises
a detection unit that detects a keypoint from a photo image generated by imaging a place in which an article is displayed,
a determination unit that determines whether a number of the detected keypoints satisfies a predetermined condition, and
an output unit that outputs a predetermined notification in a case in which the number of the detected keypoints does not satisfy the predetermined condition, and that outputs the photo image in a case in which the number of the detected keypoints satisfies the predetermined condition, and
the second information processing apparatus recognizes an article included in the photo image, using a keypoint detected from the photo image output by the first information processing apparatus.

10. The information processing system according to claim 9, wherein the predetermined condition is in that a number of keypoints detected from the whole photo image is equal to or greater than a reference value.

11. The information processing system according to claim 9, wherein
the detection unit detects a keypoint from each of one or more partial regions included in the photo image, and
the predetermined condition is in that
a total of numbers of keypoints detected from the plurality of partial regions is equal to or greater than a reference value,
all of the numbers of keypoints detected from the plurality of partial regions are equal to or greater than a reference value, or
all of the numbers of keypoints detected in equal to or greater than a predetermined number of partial regions among the plurality of partial regions are equal to or greater than a reference value.

12. The information processing system according to claim 10, wherein
the information processing apparatus accepts an input of a kind of an article included in the photo image, and
the determination unit acquires a reference value of the number of the keypoints corresponding to the input kind of the article from a storage apparatus in which a reference value of the number of the keypoints is stored in association with the kind of an article, and determines whether the number of the detected keypoints satisfies the predetermined condition using the acquired reference value.

13. The information processing system according to claim 9, wherein the predetermined notification includes a notification of prompting reimaging of the display place.

14. The information processing system according to claim 9, wherein the predetermined notification includes a view representing a partial region in which the number of detected keypoints is less than a reference value.

15. The information processing system according to claim 14, wherein the predetermined notification includes a magnified view of the partial region in which the number of detected keypoints is less than the reference value.

16. A control method executed by a computer, the control method comprising:
detecting a keypoint from a photo image generated by imaging a place in which an article is displayed;
determining whether a number of the detected keypoints satisfies a predetermined condition; and
outputting a predetermined notification in a case in which a number of the detected keypoints does not satisfy a predetermined condition.

17. The control method according to claim 16, wherein the predetermined condition is in that a number of the keypoints detected from the whole photo image is equal to or greater than a reference value.

18. The control method according to claim 16, wherein
detecting a keypoint from each of one or more partial regions included in the photo image and
the predetermined condition is in that
a total of numbers of keypoints detected from the plurality of partial regions is equal to or greater than a reference value,
all of the numbers of keypoints detected from the plurality of partial regions are equal to or greater than a reference value, or
all of the numbers of keypoints detected in equal to or greater than a predetermined number of partial regions among the plurality of partial regions are equal to or greater than a reference value.

19. The control method according to claim 17, further comprising
accepting an input of a kind of an article included in the photo image, and
acquiring a reference value of the number of the keypoints corresponding to the input kind of the article from a storage apparatus in which a reference value of the number of the keypoints is stored in association with the kind of an article, and
wherein determining whether the number of the detected keypoints satisfies the predetermined condition, using the acquired reference value.

20. The control method according to claim 16, wherein the predetermined notification includes a notification of prompting reimaging of the display place.

21-24. (canceled)
